(19) United States
(12) Patent Application Publication
(10) Pub. No.: US 2012/0017502 A1
(43) Pub. Date: Jan. 26, 2012

(54) Vegetable Support Cage

(76) Inventor: Stephen Woehler, Thorntown, IN (US)

(21) Appl. No.: 13/190,458

(22) Filed: Jul. 25, 2011

Related U.S. Application Data
(60) Provisional application No. 61/367,258, filed on Jul. 23, 2010.

(51) Int. Cl. A01G 17/06; B23P 11/00

(52) U.S. Cl. 47/45; 29/428

(57) ABSTRACT

A plant support structure. The plant support structure includes a cord secured to pegs on a plurality of stakes. The stakes are inserted into the ground and are typically vertically oriented. The stakes have pegs between which the cord can be secured to provide a support for a plant. Each stake has a plurality of pegs and plant support can be formed in multiple places between each stake. The stakes can be inserted into the soil in a variety of orientations depending on the application, and the stakes may include a cross-member securing two stakes together.

### CROSS-REFERENCE TO RELATED APPLICATION

This application claims the benefit of Provisional Patent Application No. 61/367,258, filed Jul. 23, 2010, which application is hereby incorporated by reference.

### BACKGROUND OF THE INVENTION

The present invention relates to the field of horticulture and, more specifically, a support structure for plants.

Some plants develop fruit which can become heavier than the plant can support. In such cases the stems or vines may break or split and damage the plant. This may cause the fruit on the damaged stem or vine to cease development before the fruit is fully mature.

Plants bearing heavy fruit can be damaged due to the weight of such fruit on delicate stems. A tomato plant is an example of a plant which has delicate stems which may not support the weight of the fruit it bears. The damage caused by the development of fruit on stems which cannot support such heavy loads can be mitigated or eliminated by support structures such as stakes, cages, or trellises. The stems bearing heavy fruit can be supported by a support structure which reduces the strain on the stems caused by the fruit.

Present support structures can be difficult to store when not in use during the growing season or can be difficult to position if the support structure has not been put in place early in the development of the plant to be supported. Some support structures are made of components which can be disassembled when not in use to facilitate convenient storage, but the component systems can be less convenient to reassemble or can cause frustration if components are misplaced. Some support structures are rigid and can cause additional damage to the plant or require a rigid device to couple the plant to the support structure. Some support structures make harvesting of the fruit difficult due to the diminished access to the plant caused by the support structure. Some stakes may be interconnected with a cord to support a plant, but a great length of cord may have to pass through a loop in the stake. This may be difficult and time consuming. What is needed is a support structure which is compact when stored, readily assembled, and provides support which does not damage plants.

### SUMMARY OF THE INVENTION

The present invention provides a plant support structure for inserting into soil. One aspect of the support structure includes a plurality of stakes. A plurality of pegs are rigidly fixed to each of the stakes and protrude from the surface of the stakes. A non-abrasive cord is included and spans between pegs on different stakes.

Another aspect includes a first pole and second pole which are each bent to form two elongate sections which are coupled together by a cross-member. A plurality of screws are fixed to each on the elongate sections and the screw heads are not in contact with the surface of the elongate sections to which the screws are fixed.

Another aspect includes a method of forming a plant support structure which includes using a plurality o stakes, each having a plurality of pegs extending perpendicularly therefrom. The plurality of stakes are inserted into soil so that the stakes are substantially vertical, and a cord is secured between a first peg on a first stake and a second peg on a second stake.

### BRIEF DESCRIPTION OF THE DRAWING

FIG. 1 shows a plant support structure with a cord interconnecting the pegs of two sets of stakes.

FIG. 2 shows a set of stakes rigidly connected with a cross-member.

FIG. 3 shows pegs which are offset.

FIG. 4 shows a peg having a rod and a broad head.

FIG. 5 shows a stake with pegs on multiple sides.

FIG. 6 shows multiple sets of stakes interconnected with a cord.

### DETAILED DESCRIPTION OF PREFERRED EMBODIMENTS

For the purpose of promoting an understanding of the principles of the invention, reference will now be made to the embodiments illustrated in the drawing and specific language will be used to describe the same. It will nevertheless be understood that no limitation of the scope of the invention is thereby intended, such alterations and further modifications in the illustrated device and such further applications of the principles of the invention as illustrated therein being contemplated as would normally occur to one skilled in the art to which the invention relates.

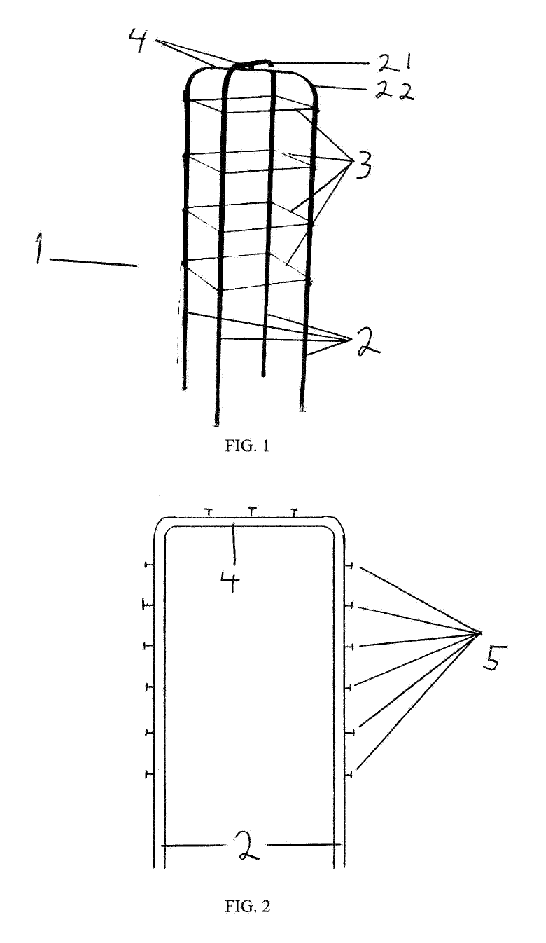

FIG. 1 shows a first embodiment of a plant support structure 1. The plant support structure includes a plurality of stakes 2 which are interconnected with cord 3. Two stakes may be connected with a cross-member 4 and form a set of stakes as shown in FIG. 2. The support structure of FIG. 1 includes a first set of stakes 21 and a second set of stakes 22 arranged so that the cross-members of the first and second sets are perpendicular and the stakes are in a square pattern.

In some embodiments a pipe is bent in two places to form a set of stakes with a cross-member rigidly connecting the stakes. The pipe may be 10 feet in length and 1/2 inch in diameter. A bench-mounted pipe bending machine can be used to make the two 90 degree bends which are about 1-2 feet apart. The pipe is bent so that the stakes are parallel and extending in the same direction away from the cross-member. One broad bend may be used instead of two bends so long as the stakes 2 are substantially extending in the same direction away from the cross-member after bending the pipe. A set of stakes with one broad bend may have a cross-member which is curved. The stakes may be made of steel, aluminum, or any other material which is substantially rigid so as to support the weight of plants.

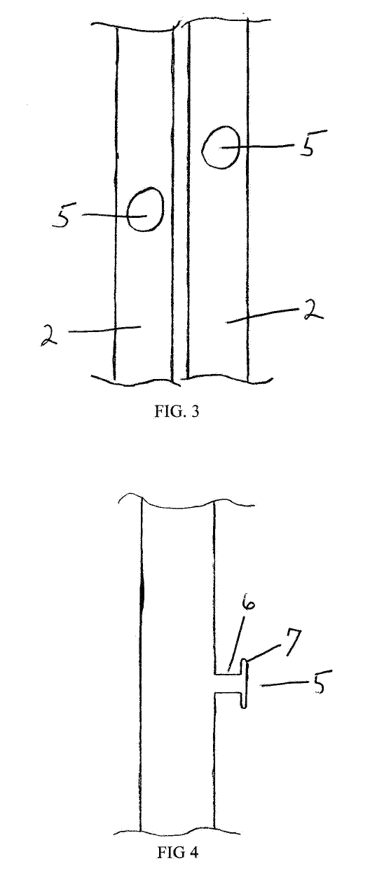

Each stake has a plurality of pegs 5 which protrude from the stakes. The pegs are vertically spaced apart. The pegs may be vertically spaced about 6-10 inches. The spacing may be up to 16 inches in some embodiments and as little as 1 inch other embodiments, and the spacing need not be uniform. The embodiment shown in FIG. 1 has four pegs on each stake, but a stake may contain any number of pegs depending on the application. The peg 5 may include a rod 6 coupled to a broad head 7 as shown in FIGS. 3-4. Alternatively, the peg may not have a head which is broader than the rod.

When two sets of stakes are used in a crisscross pattern, the pegs in the first set may be offset compared to the second set so that the corresponding pegs on each set may be horizontally aligned even though the cross-members are not horizontally aligned due to the crisscross orientation whereby one cross-member is higher from the ground. FIG. 3 illustrates corresponding pegs which are offset.

The pegs 5 should protrude from the stakes 2 so that a cord 3 may be wrapped around the peg and be supported. In some embodiments the peg will have a broad head 7 which will prevent a cord from slipping off of the peg if there were slack in the cord. The pegs may be self-tapping screws which are inserted into the stakes. The screw is partially inserted so as to be sufficiently coupled to the stake and to allow space between the stake and the head of the screw so that the cord may be wrapped around the screw. The head may be about 1/4 inch from the stake. In some embodiments, pegs may also be fixed to the cross-member.

The crisscross pattern formed by the cross-members, shown in FIGS. 1 and 6, can provide the support structure with greater rigidity and may not necessitate placing the stakes in the ground as far as would be required with stakes which are not in a crisscross pattern. Various arrangements may be formed to create a support structure, but the support structure should include at least two stakes or at least one set of stakes and may include more stakes or sets of stakes.

Some embodiments of a set of stakes have a mark on cross-member designating the center point between the stakes. The mark can be used as a guide when arranging sets of stakes in a crisscross pattern. The marked center point of each cross-member can be vertically aligned and the cross-members perpendicularly oriented to form a support structure with evenly spaced stakes in a square pattern.

In some embodiments the cross-members of a first and second set of stakes may be pivotally connected near the mid-point of each cross-member. It may be desirable to form the first set with stakes that are wider apart than the second set so that the second set may nest inside the first set. Such embodiments may be more convenient to store.

The stakes should be inserted into the ground a sufficient amount so that they will remain upright. Generally, inserting the stakes to a depth of 3-8 inches is sufficient, but the sufficient depth will vary depending on soil quality and moisture content. The stakes may include markings on the lower portion to allow the installer to assess the depth of insertion and may include an installation peg which can be stepped on with the foot of the installer so as to drive the stake into the ground. The installation peg is perpendicular to the stake.

A cord 3 is wrapped around the pegs to provide support for a plant. The cord should be flexible, not abrasive, and have a sufficient thickness which will support the plant without cutting into the plant. Abrasive materials can damage plant stems when the stems are blown in the wind. Parachute cord is a good cord type because it is flexible, has some stretch, is not abrasive and is durable such that it can be used for multiple years. Parachute cord has a braided sheath around core. The nylon sheath of a parachute cord is not abrasive.

The cord is tied to a peg to fix the cord to a stake. It may be more convenient to tie the cord to a peg which will be part of either an upper-most or lower-most support tier. After the cord is secured to a first peg on a first stake, the cord can then be secured to a second stake having a second peg which is substantially horizontally aligned with the first peg, although, as shown in FIG. 6, the cord does not have to horizontally interconnect pegs on different stakes. Preferably, the cord wraps around each peg so that the cord extends from the upper portion of one peg to the upper portion of a second peg. The wrapping process may be repeated until all pegs in the first horizontal tier have been wrapped with the cord.

The cord is then wrapped around each peg in a second horizontal tier. Preferably the same cord that is used to wrap the first horizontal tier is used to wrap each peg in the second tier. The cord is stretched between a peg in the first tier level and a peg in the second tier. Each peg in the second tier is then wrapped with the cord. This process continues until the cord has been secured to each peg in each tier. The cord should be knotted to the final peg to fix the cord to the stake or peg. One cord may interconnect all pegs or multiple cords may interconnect the pegs.

In some embodiments the stakes will have more pegs than necessary to adequately support a plant. Stakes with multiple pegs will allow the cord installer to choose the height of the support that the cord provides to a plant. Depending on the plant to be supported or the size of the plant when the support structure is installed, it may be desirable to have horizontal support structures at different levels on different sides of the support structure. For example, the horizontal support between stakes one and two may be 18 inches off the ground, but the horizontal support between stakes three and four may be 20 inches off the ground. This may be beneficial after a plant has grown a certain amount and has stems on different sides which require support at different heights.

In alternative embodiments the cord is a stretchable material for coupling to less than all of the pegs. Bungee cord is an example of a more stretchable material. In some embodiments the cord is a loop. Stretchable loop cord may be wrapped around a plant stem and then coupled to two or more pegs. A loop cord provides a great deal of variability for supporting the plant. A loop cord can provide a gardener the ability to add support to a plant as it grows and add horizontal support structures at a variety of levels.

Additional cord may be coupled to the stakes as the plant grows. As the plant grows in a multitude of directions, a cord may be added to support a specific part of the plant.

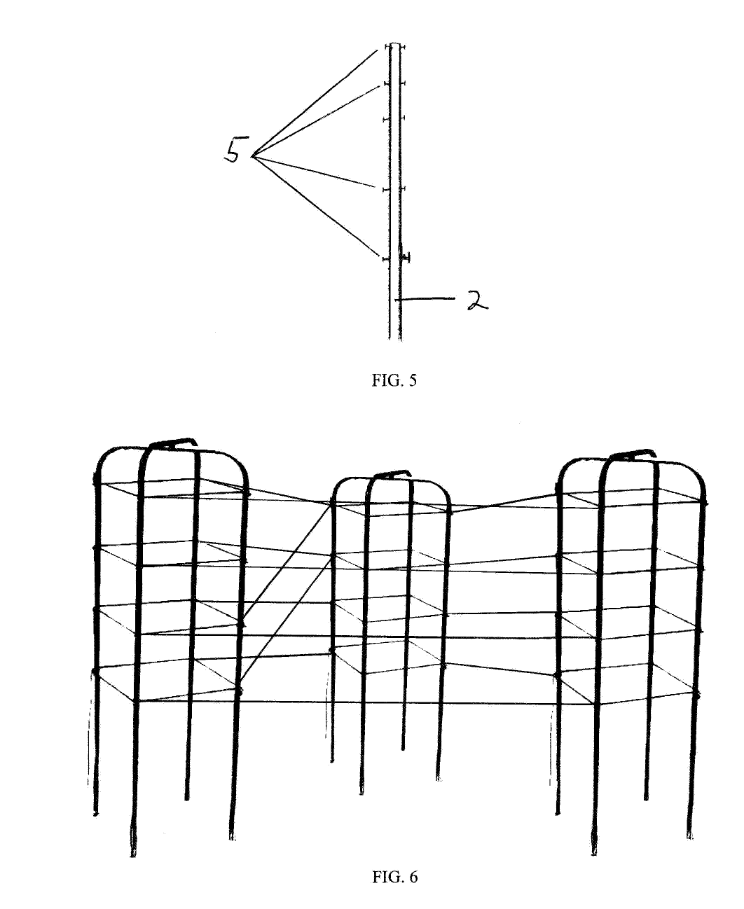

In some embodiments the stakes are not interconnected. FIG. 5 shows a stake that is not interconnected to another stake by a cross-member. The stake in FIG. 5 has pegs which are on multiple sides of the stake.

FIG. 6 shows an embodiment where a plurality of sets of stakes are oriented in a crisscross pattern whereby the cross-members of two sets are perpendicular and the crisscross structures are interconnected with cord. In this arrangement the cords may span a greater length between pegs may provide support to a greater area of plants.

While the invention has been illustrated and described in detail in the drawings and foregoing description, the same is to be considered as illustrative and not restrictive in character, it being understood that only preferred embodiments have been shown and described and that all changes and modifications that come within the spirit of the invention are desired to be protected.

What is claimed:

1. A plant support structure for inserting into soil, comprising:
a plurality of stakes;
a plurality of pegs rigidly fixed to each of said stakes, said pegs protruding from surface of said stakes; and
a cord for wrapping around said pegs, wherein said cord has a nonabrasive surface, and wherein said cord spans between pegs on different stakes.

2. The structure of claim 1, wherein two of said stakes are rigidly coupled to a first cross-member, and wherein said two stakes and said first cross-member form a first set of stakes.

3. The structure of claim 2, further comprising another two stakes, wherein said another two stakes are rigidly coupled to a second cross-member, and wherein said another two stakes and said second cross-member form a second set of stakes.

4. The structure of claim 3, wherein said first cross-member is perpendicular to said second cross-member.

5. The structure of claim 2, wherein said first cross-member is integrally formed with said two stakes.

6. The structure of claim 1, wherein said cord is parachute cord.

7. The structure of claim 1, further comprising a plurality of cords, wherein one or more of said plurality of cords are loops.

8. The structure of claim 7, wherein said cords are bungee cords.

9. The structure of claim 1, wherein said pegs are screws.

10. The structure of claim 1, wherein each of said pegs has a rod with an axis that is substantially perpendicular to the axis of said stake to which said peg is rigidly fixed.

11. The structure of claim 2, wherein said first cross-members includes one or more pegs.

12. The structure of claim 3, wherein said first cross-member and said second cross-member are pivotally connected substantially near their midpoints.

13. The structure of claim 12, wherein the stakes of said second set fit within the span between the stakes of said first set.

14. A plant support structure for inserting into soil, comprising:
a first pole that is bent to form two elongate sections which are coupled together by a cross-member;
a second pole that is bent to form two elongate sections which are coupled together by a cross-member;
a plurality of screws fixed to each of said elongate sections, said screws have heads which are not in contact with a surface of said elongate section to which said screws are fixed;
a non-abrasive length of parachute cord spanning between one of said pegs on said first pole and one of said pegs on said second pole.

15. A method of forming a support structure to support a plant, comprising:
using a plurality of stakes, each having a plurality of pegs extending perpendicularly therefrom;
inserting said plurality of stakes into soil so that said stakes are substantially vertical; and
securing a cord between a first peg on a first stake and a second peg on a second stake.

16. The method of claim 15, wherein two of said stakes are rigidly coupled to a first cross-member thereby forming a first set of stakes.

17. The method of claim 16, wherein using further includes another two stakes which are rigidly coupled to a second cross-member thereby forming a second set of stakes, and wherein inserting includes orienting said first cross-member perpendicular to said second cross-member.

18. The method of claim 15, wherein securing further includes wrapping said cord around a peg on each plurality of said plurality of stakes so that said cord forms a support which surrounds a plant.

19. The method of claim 11, further comprising securing a separate second cord between two stakes.

20. The method of claim 19, wherein said second cord is a loop.
